(19) United States
(12) Patent Application Publication
(10) Pub. No.: US 2010/0232153 A1
(43) Pub. Date: Sep. 16, 2010

(54) LIGHTING DEVICE INCLUDING A PLURALITY OF LIGHT SOURCES FOR GENERATING MULTIPLE LIGHTING PATTERNS

(75) Inventors: Elizabeth H. Zwerver-Curtis, Eindhoven (NL); Petrus J. M. Van Der Burgt, Eindhoven (NL); Maria W. H. Koolman, Eindhoven (NL)

Correspondence Address: Philips Intellectual Property and Standards, P.O. Box 3001, Briarcliff Manor, NY, 10510-8001, US

(73) Assignee: KONINKLIJKE PHILIPS ELECTRONICS N V, Eindhoven (NL)

(21) Appl. No.: 12/377,519

(22) PCT Filed: Sep. 5, 2007
(86) PCT No.: PCT/IB2007/053566

§ 371 Date: Feb. 13, 2009

(30) Foreign Application Priority Data
Sep. 8, 2006 (EP) 06120355.0

(51) Int. Cl. F21S 19/00; F21V 9/00

(52) U.S. Cl. 362/228; 362/231

(57) ABSTRACT

The invention relates to a lighting device (1) comprising a plurality of light sources which are capable of emitting light towards a surface (S). The lighting device is arranged in such a way that light from at least one first light source (2) forms a first lighting pattern (I) of white light on said surface and light from a plurality of second light sources (3) forms a second lighting pattern (II) of light of a different color on said surface. The second lighting pattern substantially surrounds said first white lighting pattern.

### FIELD OF THE INVENTION

The invention generally relates to the field of lighting devices. More specifically, the invention relates to the field of lighting devices applicable for accentuating or decorating objects in order to draw attention to these objects.

### BACKGROUND OF THE INVENTION

In the last decade, competition among retailers has intensified and retailers are therefore looking for new ways to attract the attention of potential customers. Retailers have realized that the presentation of their products has a significant impact on the buying behavior of customers. One of the factors influencing the presentation of products is the manner in which these products are illuminated.

Apart from retail stores, consumers have also come to appreciate decorative lighting within their homes.

Developments in lighting technology have resulted in advanced lighting devices becoming available for daily use in retail stores and people's homes at acceptable prices.

### OBJECT AND SUMMARY OF THE INVENTION

It is an object of the invention to provide a lighting device which is capable of generating a light effect that draws attention to an object or provides decorative lighting.

To this end, a lighting device is proposed, which comprises a plurality of light sources which are capable of emitting light towards a product or surface. The lighting device is arranged in such a way that light from at least one first light source forms a first lighting pattern of white light on said surface and light from a plurality of second light sources forms a second lighting pattern of light of a different color on said surface. The second lighting pattern substantially surrounds said first white lighting pattern.

Furthermore, a lighting pattern is proposed, which comprises a first lighting pattern of white light surrounded by at least a second lighting pattern of a different light color.

By directing the white lighting pattern onto the product, the product is illuminated and has a natural appearance, whereas the surrounding lighting pattern of light of a different color than the color of the light of the first lighting pattern is capable of creating a desired ambiance and attracting and sustaining the attention of customers. The lighting device may also be used in a room, such as a living room, to accentuate a particular object. In general, the lighting device is capable of attracting an observer's attention by generating the desired lighting pattern.

Generally, the color of the light responsible for producing the second lighting pattern comprises a color other than white, such as blue, red, orange, yellow, green, etc. However, it should be noted that the light color of the second lighting pattern may also comprise white light but with different characteristics than the white light of the first lighting pattern. As an example, the first lighting pattern may be a center spot of warm white light, whereas the second surrounding lighting pattern may be a halo of cool white light.

The lighting device of claim 2 defines an embodiment for creating the desired lighting patterns by appropriate positioning of the light sources.

The embodiment of the invention as defined in claim 3 has the advantage that the lighting patterns of the lighting device can be adjusted as desired. This allows use of the same lighting device in different situations. Examples of adjusting the lighting patterns include adjusting the shape and/or size as a function of time, adjusting the light color of the second lighting pattern as a function of time, etc.

The embodiments of the invention as defined in claims 4 and 9 are advantageous in that the lighting pattern is enriched with dynamic elements in order to increase the attention of an observer.

The lighting device of claim 5 defines an alternative embodiment for adjusting at least one of the first and second lighting patterns. A controllable optical element may e.g. comprise an electrically controllable optical element.

The embodiment of the invention as defined in claim 6 is advantageous in that the diaphragm assists in obtaining better defined contours for the second lighting pattern.

It should be noted that the embodiments defined above, and aspects thereof, may be combined.

The invention will be elucidated with reference to the attached drawings, which schematically show preferred embodiments according to the invention. It will be understood that the invention is not in any way limited to these specific and preferred embodiments.

### BRIEF DESCRIPTION OF THE DRAWINGS

FIG. 1 shows schematically an embodiment of a lighting device according to the invention;

FIGS. 2A-2C are schematic examples of lighting patterns which can be produced with an embodiment of a lighting device according to the invention, and

FIG. 3 shows schematically an alternative embodiment of a lighting device according to the invention.

### DESCRIPTION OF EMBODIMENTS

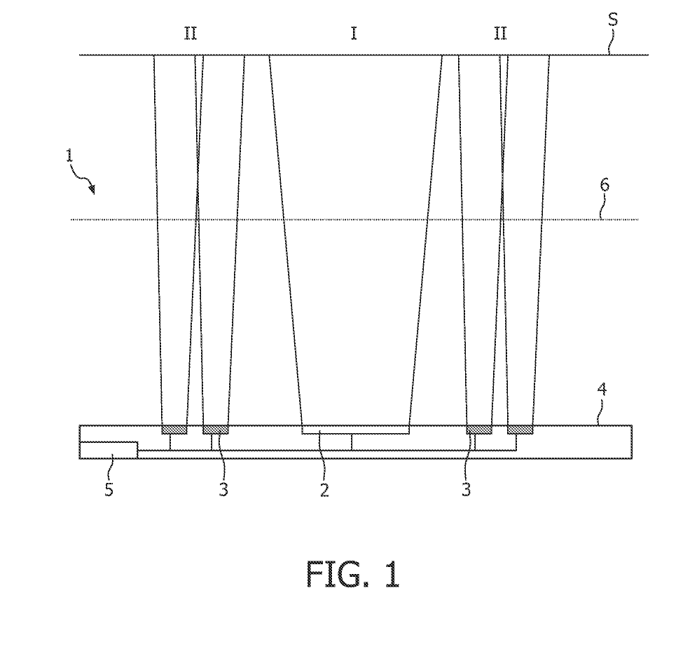

FIG. 1 shows schematically a lighting device 1 comprising a plurality of light sources which are capable of emitting light towards a surface S. The light sources in FIG. 1 comprise a first light source 2 arranged in such a way that a first lighting pattern I of white light is produced on a surface S, and a plurality of second light sources 3 producing a second lighting pattern II of a light color different from the white light of the first lighting pattern I on the surface S.

Generally, the color of the light responsible for producing the second lighting pattern II comprises a color other than white, such as blue, red, orange, yellow, green, etc. However, it should be noted that the light color of the second lighting pattern II may also comprise white light but with different characteristics than the white light of the first lighting pattern I. As an example, the first lighting pattern I may comprise a center spot of warm white light, whereas the second surrounding lighting pattern II may comprise a halo of cool white light.

The light sources 2, 3 are arranged on a substrate 4. The lighting device 1 is arranged in such a way that the second colored lighting pattern II substantially surrounds the first white lighting pattern I. The light sources 2, 3 can be controlled by a controller 5 in order to adjust the first and/or second lighting patterns I, II. The boundaries of the first and second lighting patterns I, II can be better defined by applying at least one diaphragm, indicated by the dotted line 6.

In the embodiment shown in FIG. 1, the first light source 2 is a white light source, whereas the second light sources 3 are e.g. light-emitting diodes which are capable of producing e.g. blue or red light. In one embodiment, the lighting device 1 comprises light sources, such as light-emitting diodes, which are capable of emitting red, green and blue light in order to be able to produce virtually all colors for the second lighting pattern II. Consequently, a product (not shown) positioned on the surface S can be illuminated by the first white lighting pattern I and surrounded by a second blue or red lighting pattern II. These lighting patterns may increase and sustain the attention of a particular customer to the product in the white spotlight.

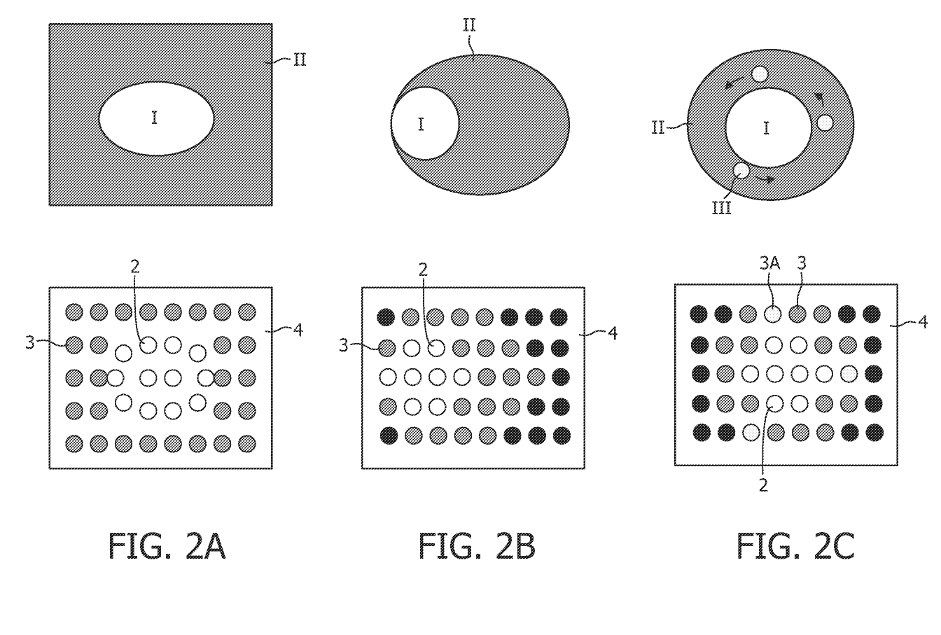

FIGS. 2A-2C are schematic examples of lighting patterns that show the first lighting pattern I and the second lighting pattern II at the top of these Figures. It should be noted that, in practice, the contours of the lighting patterns I, II are less sharp than are shown in FIGS. 2A-2C as a result of scattering and the divergent nature of light. The bottom portion of the Figures is a top view of the substrate 4 comprising the first and second light sources 2, 3.

In FIG. 2A, a lighting device 1 comprises a substrate 4 with a plurality of first white light sources 2 surrounded by a plurality of second light sources 3 which are capable of providing light of a different color on a surface. The position of the various light sources 2, 3 produces the first white lighting pattern I and the second surrounding lighting pattern II.

In FIG. 2B, the first and second light sources 2, 3 are arranged in a regular matrix pattern on a substrate 4. The controller 5 controls the operation of the light sources 2, 3, and the position and shape of the first white lighting pattern I and the second lighting pattern II may thus be adjusted as desired. In FIG. 2B, the light sources indicated by white circles are the white light-emitting light sources 2 and the gray circles indicate the second light-emitting light sources 3 that provide the light of a different color. The black circles indicate light sources that are not in operation. Consequently, a circular white lighting pattern I is substantially surrounded by an oval second lighting pattern II of a different light color, and the circular white lighting pattern is positioned away from the center point of the oval second lighting pattern.

FIG. 2C shows a further combination of lighting patterns I, II produced with the same lighting device 1 as in FIG. 2B under the control of the controller 5. Again, the white light sources 2 are indicated by the white circles, the light sources 3 providing the other light color are indicated by the gray circles and the black circles indicate light sources that are not in operation. The white lighting pattern I is circular and centered within the lighting pattern II of a different light color. Moreover, the controller 5 is arranged to selectively control some of the second light sources 3, here indicated by reference numeral 3A, such that said light sources 3A form lighting patterns III varying in position substantially within the lighting pattern II. The moving lighting patterns III within the lighting pattern II assist in drawing attention to an object (not shown) positioned in the white lighting pattern I.

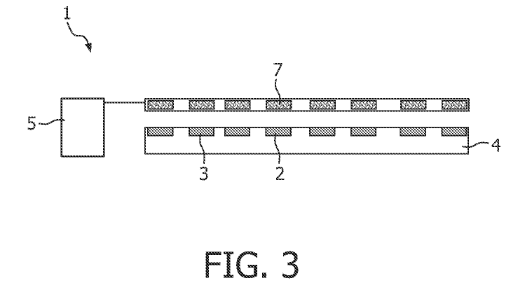

FIG. 3 shows an alternative embodiment of a lighting device 1. Instead of controlling the light sources 2, 3, the lighting device comprises a switchable optical element 7 that can be controlled from the controller 5 in order to adjust the lighting patterns I, II. The optical element 7 may be e.g. an electrically controllable optical element 7. The optical element may comprise a shutter for preventing particular light sources 2, 3 from contributing to the lighting patterns I, II.

It should be noted that the lighting device 1 of FIG. 3 may also comprise a diaphragm for improving the contours of at least one of the first and second lighting patterns I, II.

It should further be noted that a lighting device 1 may comprise a controller 5 arranged to control the light sources 2, 3 as well as an optical element 7.

The light sources 2, 3 that may be used for the lighting device 1 of the invention include incandescent lamps, halogen lamps (possibly using colored filters), light-emitting diodes or high-intensity discharge lamps.

The controller 5 may be capable of controlling at least one of the shapes and sizes of the lighting patterns I, II, III and the hue, saturation and brightness of the emitted light. The user of the light can adjust the first and second lighting patterns independently of each other. Control and adjustment may be conducted automatically as a function of time.

Various lighting patterns may be produced with the lighting device 1 of the invention. Further lighting patterns may e.g. surround the first and second lighting patterns I, II.

Furthermore, the effect of the second lighting pattern II surrounding the first lighting pattern I should only be visible at the illuminated surface S. Such an effect may also be obtained by e.g. a powerful white light source 2 providing the first lighting pattern I and thereby rendering light from second light sources in the same area on the surface S invisible or nearly invisible, whereas the light from these second light sources 3 is visible as the second lighting pattern outside the first lighting pattern I.

The lighting device 1 of the invention fulfills the retailer's latent need to play on changing retail themes by means of a flexible lighting system. The lighting device 1 allows the retailer to draw attention to his merchandise and render it beautiful at the same time. The merchandise looks natural under the white first lighting pattern I.

In the claims, any reference signs placed between parentheses shall not be construed as limiting the claim. Use of the verb “comprise” and its conjugations does not exclude the presence of elements or steps other than those stated in a claim. Use of the article “a” or “an” preceding an element does not exclude the presence of a plurality of such elements. The mere fact that certain measures are recited in mutually different dependent claims does not indicate that a combination of these measures cannot be used to advantage.

1. A lighting device comprising a plurality of light sources capable of emitting light towards a surface (S), wherein said lighting device is arranged in such a way that the light from at least one first light source forms a first lighting pattern of white light on said surface and the light from a plurality of second light sources forms a second lighting pattern of colored light on said surface, such that said second lighting pattern substantially surrounds said first lighting pattern.

2. The lighting device according to claim 1, wherein said at least one first light source is at least partially surrounded by said plurality of second light sources.

3. The lighting device according to claim 1, wherein said lighting device comprises a first controller for selectively controlling at least one of said first and second light sources for adjusting at least parameter of at least one of said first and second lighting patterns.

4. The lighting device according to claim 1, wherein said lighting device comprises a first controller for selectively controlling at least one second light source to form one or more third lighting patterns varying in position relative to said second lighting pattern.

5. The lighting device according to claim 1, wherein said lighting device further comprises at least one optical element for controlling the light emitted from at least one of said first and second light sources and a second controller arranged to control said optical element for adjusting at least one parameter of said first and second lighting patterns.

6. The lighting device according to claim 1, wherein said lighting device further comprises at least one diaphragm for defining a contour of at least one of said first and second lighting patterns.

7. The lighting device according to claim 1, wherein said first and second light sources are selected from the group consisting of: incandescent lamps, halogen lamps, LEDs and high-intensity discharge lamps.

8-10. (canceled)
